(19) United States
(12) Patent Application Publication
(10) Pub. No.: US 2015/0066343 A1
(43) Pub. Date: Mar. 5, 2015

(54) Method and system for improved fuel mileage measurement

(71) Applicant: Echo Automotive, Inc., Scottsdale, AZ (US)

(72) Inventor: Jeff Ronning, Noblesville, IN (US)

(21) Appl. No.: 14/013,033

(22) Filed: Aug. 29, 2013

(51) Int. Cl. G01F 9/02; H02P 3/14

(52) U.S. Cl. CPC G01F 9/023; H02P 3/14
USPC 701/123; 318/376

(57) ABSTRACT

The subject invention is directed to a method and system for generating an improved fuel mileage value for a powered vehicle. Said method and system take into account real-time operational parameters of a vehicle, such as the rate of fuel consumption, vehicle velocity, vehicle acceleration and deceleration, the kinetic and potential energy of the vehicle, and the energy recovered by regenerative braking.

In one set of applications, the improved fuel mileage value generated by said method and system provides timely and positive feedback and psychological reinforcement to vehicle operators to encourage fuel-efficient vehicle operations. Such feedback and psychological reinforcement are especially valuable when a regenerative vehicle braking system is being used. Said value can also provide feedback of the operational efficiency to an automated or semi-automated throttle and/or braking system.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present disclosure relates generally to the technical field of vehicle fuel mileage measurement. More specifically, it relates to a method and system for sensing and processing real-time operational parameters of a vehicle, and generating from information comprising said real-time operational parameters an improved fuel mileage value for said vehicle. The improved fuel mileage value (herein called LIVEmpg) can be displayed as feedback to the operator of said vehicle, as feedback for a fuel saving vehicle controller, or used in any other manner which serves the needs of the vehicle operator or owner.

Rising global fuel prices have improved business prospects for manufacturers of fuel-saving systems. In particular, fleet operators often use their fueled vehicles for purposes (e.g., urban delivery) for which such vehicles exhibit poor fuel mileage.

Existing vehicles waste substantial fuel when they decelerate using friction brakes, and when operating the engine under conditions which lead to low efficiency. Electric vehicles, hybrid vehicles, advanced transmissions, and regenerative braking have to some extent addressed these problems, but most operators lack the knowledge of how to drive such vehicles in the most efficient manner.

There is thus a need for a simple, effective, and inexpensive method and system to sense selected operating properties of a vehicle, acquire said operating properties as data, and generate therefrom an improved fuel mileage value that can be used as feedback concerning the fuel efficiency of the vehicle.

### SUMMARY OF INVENTION

The subject invention is directed to a group of methods and systems for determining the fuel mileage of a vehicle. One aim of such methods and, systems is to provide real-time feedback concerning fuel mileage so that an operator or an automatic system can control the vehicle with improved fuel efficiency.

Certain embodiments include sensors attached to a vehicle, general-purpose or special purpose computers to carry out the specified calculations to return an improved fuel mileage value for display or feedback for a vehicle control system. Factors that can be included as input to such a system include fuel consumption, weight, vehicle weight, vehicle speed, vehicle elevation, regenerative braking storage, and other factors which cause LIVEmpg to vary from the industry-standard OEM raw fuel mileage, evaluated as vehicle speed divided by the raw fuel consumption rate of the vehicle. Combinations of features of the embodiments herein described are included in the subject invention, as are embodiments which exclude certain of the above features.

Embodiments of the instant invention exist which have more than one engine and source of energy that can be used to propel a vehicle. In some of those embodiments a LIVEmpg parameter will be generated that reflects only the fuel mileage associated with one such source of energy. In other embodiments a combined LIVEmpg parameter will be generated that reflects overall fuel economy of said vehicle. In still other embodiments a combined LIVEmpg parameter will be generated that reflects overall energy usage of said vehicle.

Certain aspects of the subject invention are set forth below. It should be understood that the aspects shown and discussed are not intended to limit or exhaust the scope of the invention, which limits are expressed in the appended claims as interpreted by one skilled in the art.

### BRIEF DESCRIPTION OF THE DRAWINGS

FIG. 1 shows a schematic view of a simple embodiment of the instant invention.

FIG. 2 shows a schematic view of an embodiment of the instant invention wherein the LIVEmpg is corrected so that the integral of LIVEmpg during a trip is substantially equal to the amount of actual fuel used in that trip.

FIG. 3 shows a schematic view of an embodiment of the instant invention wherein the LIVEmpg value includes the effects of regenerative braking.

### DETAILED DESCRIPTION OF THE INVENTION

The purpose of the instant invention is to enable a method and system to generate an improved fuel mileage value, called LIVEmpg, for a fueled vehicle. The improved fuel mileage value provided by the instant invention not limited to a single perfect value, but rather is one of a class of improved fuel mileage values generated by various implementations of the instant invention. The improved fuel mileage value can be used for operator feedback, feedback to an automatic throttle control, or such other applications as have utility to the vehicle operator or owner.

In a fueled vehicle, the consumption of fuel is the source of motive force. The term “fuel” is herein used to denote any source of energy that can be applied to vehicle propulsion, including but not limited to chemical and electrical energy. In particular, “raw fuel” is the term used herein for a fuel that drives an engine in a vehicle. As an example, gasoline would be a raw fuel for a vehicle with a gasoline-burning engine.

A particular novelty of the instant invention is the realization that energy stored as kinetic or potential energy is also energy that can be applied to vehicle propulsion. For example, the mechanical kinetic energy of a vehicle of mass m moving at a speed V is well known to be equal to 0.5 mV². Similarly, the mechanical potential energy of a vehicle of mass m that has climbed a hill of height h has increased by mgh. Such mechanical energy of motion and place is herein called “stored fuel”.

What practical utility results by keeping track of the amount of stored fuel of a vehicle? Doing so allows the instant invention to better reflect the actual fuel economy of a vehicle.

Applicant here introduces a term, RAWmpg, which is the present vehicle speed divided by the present rate of raw fuel consumption. RAWmpg is the conventional definition of the fuel mileage of a vehicle. Note that the rate of consumption of raw fuel is positive, even though the amount of fuel contained in the vehicle is becoming smaller.

Here is an example of how RAWmpg can be a misleading parameter. Imagine a truck on a flat surface that has accelerated to a speed of 80 mph. Now put the transmission into neutral and shut down the engine, causing the consumption of raw fuel to cease. If brakes are not applied, the truck will coast down the road until the drag of the moving truck consumes the kinetic energy stored in the motion of the truck. During this period of coasting, the RAWmpg would appear infinite, as the vehicle is moving at a time when no raw fuel is being consumed.

In reality, however, as the truck was accelerating to 80 mph, a portion of the raw fuel consumed during such acceleration was effectively converted into a different type of fuel for the vehicle, in the form of kinetic energy. This “stored fuel” begins the coasting period at a positive value, then falls to zero during the coasting period, and thus is “being consumed” during that period.

Note that during acceleration of the truck, the amount of stored fuel increases, which corresponds to negative consumption of stored fuel. This simply states that as the vehicle speed increases, the amount of stored fuel also increases, during which time the negative consumption reflects the rate of storage of kinetic energy.

The conversion of an amount of stored energy into an equivalent amount of stored fuel can be approximated in many ways, some of which will be described in detail later, and all of which are intended to be within the scope of the instant invention. Roughly speaking, however, the amount of stored fuel is equal to the stored mechanical energy of a vehicle divided by the volumetric energy density of the vehicle's raw fuel, and ideally is corrected to take into account the thermodynamic efficiency of the vehicle engine.

Note that for a hybrid vehicle (e.g., one using an internal combustion engine and gasoline together with an electric motor and a storage battery), a LIVEmpg value based solely on gasoline usage can be of considerable value in monitoring and optimizing the cost of running the vehicle. This is particularly true when the cost of electric energy is far less than the cost of an equivalent amount of gasoline.

The behavior described above and related phenomena suggest that a fuel mileage value that accurately reflects the effect of driving style should be based on the consumption of the sum of the volume of raw fuel and the equivalent volume of stored fuel. This sum is herein termed live fuel.

For definiteness, the rate of consumption of raw fuel is termed RAWgph, the rate of consumption of stored fuel is termed STOREDgph, and the rate of consumption of live fuel is termed LIVEgph. For convenience, the rate of consumption has units of gallons per hour for the purposes of this specification, although the specific units used in a particular implementation may be different.

In analogy to the industry-standard instantaneous RAWmpg, we can define a LIVEmpg value as being substantially equal to the vehicle speed divided by LIVEgph, the rate of consumption of live fuel. Methods and systems to measure and monitor the LIVEmpg form a considerable part of the instant invention.

An important reason to monitor LIVEmpg values that include the effects of stored fuel is that the raw mpg provides inaccurate feedback about the efficiency of a vehicle. This was seen in the earlier example of infinite RAWmpg during coasting. In another example, the RAWmpg value will indicate that a vehicle is wasteful of fuel while accelerating, while in reality, acceleration is often one of the most efficient periods of operating a vehicle.

RAWmpg appears low during acceleration because it does not reflect that most of the raw fuel consumed during acceleration is being converted into kinetic energy of the vehicle—that is, into stored fuel. The LIVEmpg value does reflect this storage, and therefore gives a larger value for mileage during acceleration than does the conventional RAWmpg value.

Most of the thermal energy released by burning a fuel in a heat engine is wasted in the heat engine and the mechanical powertrain elements. (Similar statements hold for other forms of engine.) The fuel mileage of a fueled vehicle is a function of the thermodynamic efficiency of the engine and powertrain. However, in some implementations of the instant invention, a numerical value for the thermodynamic efficiency need not be known to generate a LIVEmpg value.

Note that much of the utility of the LIVEmpg value defined above is retained if a function of the LIVEmpg value (e.g., LIVEmpg+C, K*LIVEmpg, or ✓LIVEmpg) is substituted for the “true” LIVEmpg. This goes back to the practical use of a LIVEmpg value as useful feedback to a vehicle operator or to a vehicle subsystem. The use of the term “LIVEmpg” going forward in this specification is intended to include all such deformations of the “true LIVEmpg” value defined above.

A number of approaches toward extracting LIVEmpg from information comprising certain real-time vehicle operating parameters of a given vehicle are described herein. It is not intended that the instant invention is limited to these specific implementations, but rather that the invention should include all implementations consistent with the design principles and which are clear to one skilled in the art given the current disclosure.

Consider a vehicle accelerating from a stationary position. A part of the energy expended during acceleration is stored as mechanical (kinetic and potential) energy of the vehicle, while the remainder is lost to heat, drag, friction, noise, and possibly such conveniences as air conditioning and radios. There is nowhere else for the energy to go. Thus, as the vehicle accelerates, a part of the total motive power (TP) of the vehicle increases the speed of the vehicle, and is called acceleration power (AP).

Acceleration power can be expressed as vehicle mass m times vehicle speed V times vehicle acceleration a. Note that if assuming constant mass is reasonable, acceleration power can be found given only the time-dependent vehicle speed. The remainder of the total motive power of the vehicle is irretrievably lost, and that remainder is called road load.

Road load (RL) is a useful concept to enable splitting of raw fuel consumption, because it is the portion of the power that does not change the mechanical energy of the vehicle. While friction and drag always act to drain mechanical energy from a vehicle, we herein express road load as a positive number, meaning the amount of motive power which must be applied to the vehicle to offset the friction and drag.

In many cases, road load can adequately be approximated as a function of vehicle speed V which is specific to a particular vehicle, rather than being measured in real-time. That this is an approximation can be seen by thinking of the road load as frictional loss of energy.

It is certainly possible that in cruising at a given vehicle speed there may be no slip in a vehicle's drivetrain, leading to high efficiency. When accelerating rapidly past that speed, however, the increase of torque delivered to the wheels may reasonably result in some drivetrain slippage, and the grip of the tires on the road will be different than when cruising. In such a case, the road load is actually a function of at least speed and acceleration. Such more complex road load factors often cause only very small changes in LIVEmpg, and in any case can be accommodated by one skilled in the art given the present disclosure.

In a specific case, Applicant has experimentally determined the road load of a Ford E-250 van to be RL 200V+5V²+0.9V³ (V is in meters/second and the road load is in watts.) When such a van is driven at a vehicle speed of 80 mph, for example, the van required about 55 kW (72 hp) simply to overcome friction and drag.

Whereas the raw mpg value is found by dividing the vehicle speed by the rate at which raw fuel is consumed (RAWgph), the LIVEmpg parameter is generated by dividing the vehicle speed by the LIVEgph.

LIVEmpg=Vehicle mph/LIVEgph.

A scaling approach can be used to work out the LIVEgph and LIVEmpg values. We know that

TP=RL+AP,

where RL is a function of the vehicle speed and AP is calculated from the basic dynamic parameters of the vehicle motion. We also know that the total power is the mechanical power ultimately provided by consumption of raw fuel. Accordingly, the portion of the total power going to overcome the road load is RL/TP, or RL/(RL+AP). The total power is being generating by the rate at which fuel is being consumed, called RAWgph, which is directly measured as volume leaving the fuel tank.

Given the above, the rate at which stored fuel is being increased (we are looking at positive accelerations here) is simply:

STOREDgph=RAWgph*[AP/TP]

The remainder of the raw fuel consumption goes to overcome road load:

LIVEgph(during acceleration)=RAWgph*[RL/TP]

While more complex vehicular systems can be treated, this is the basic idea underlying the instant invention. In brief, the amount of fuel being used to propel a′vehicle during positive acceleration is equal to the total amount of raw fuel consumption times the fraction of that fuel consumption used to overcome road load. This gives the LIVEgph value, and then LIVEmpg is just

LIVEmpg=Vehicle speed V(mph)/LIVEgph.

Similar mathematical approaches are required to handle negative acceleration and the difference between kinetic energy (which depends on velocity) and potential energy (which depends on altitude). Those not discussed below can easily be derived and programmed by one skilled in the art.

Clearly, any reasonable LIVEgph value will indicate higher fuel mileage during acceleration than will raw mpg, which ignores kinetic energy storage. Similarly, a reasonable LIVEmpg value will also indicate smaller LIVEmpg values during coasting and braking than the raw mpg value indicates, as stored fuel is being “consumed” as slowing down reduces the kinetic energy of the vehicle.

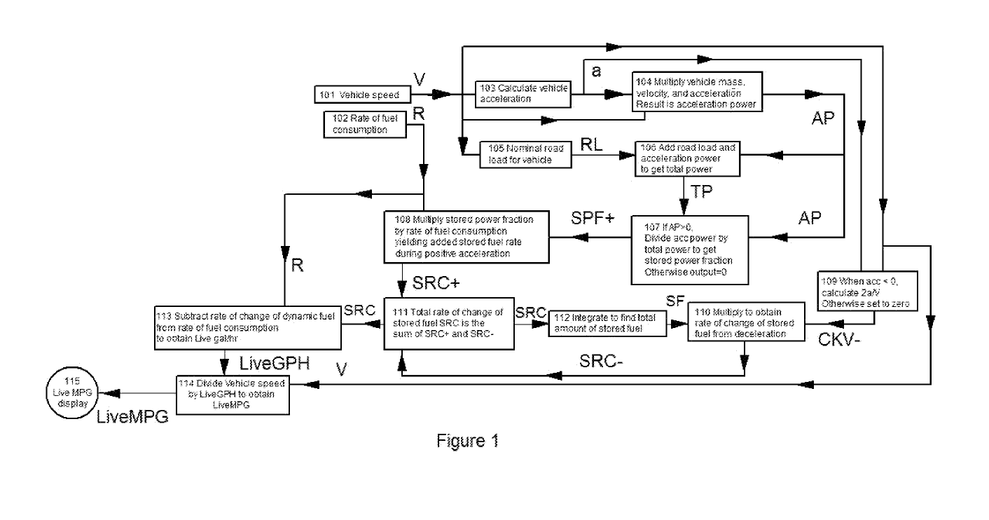

A basic implementation of the instant invention that only compensates for storage of kinetic energy is shown schematically in FIG. 1. Imagine a vehicle moving about on a flat plane, so that the potential energy of the vehicle remains constant. The only real-time vehicle parameters required in this implementation of the instant invention are vehicle speed V made available through element 101 and the rate RAWgph at which raw fuel is consumed by the vehicle as made available through element 102. In this implementation the assumption is being made that the mass of the vehicle does not change enough that the LIVEmpg values must be altered to correct for such changes. Such alteration is, of course, possible within the scope of the instant invention. The goal of this implementation is to generate a LIVEmpg value that provides useful feedback to a vehicle operator to help reduce wasteful activities like braking and idling.

Note that FIG. 1 shows both the flow of the data analysis and defines the sensing, numerical, and output operations that must be carried out during the operation of this implementation of the instant invention.

The sensing, numerical, and output operations can be carried out by means comprising the use of digital data, analog data, or a combination thereof. The sensing, numerical, and output operations can be carried out by means comprising general-purpose computers, special-purpose computers, or a combination thereof. The sensing, numerical, and output operations can be carried out by means comprising electronic devices, electromechanical devices, mechanical devices, or a combination thereof. The sensing, numerical, and output operations can be carried out as directed by means comprising machine-readable instructions. The scope of the instant invention is not intended to be limited to the implementation of FIG. 1 and the accompanying discussion, but only by the scope of the claims presented below.

First we describe how to calculate the amount of stored fuel that corresponds to the storage of kinetic energy during positive vehicle acceleration a. This is carried out by elements 101-108.

The instant invention would provide utility if it simply kept track of the kinetic energy of the vehicle and applying thereto a fuel efficiency correction function to convert the kinetic energy of the vehicle into an equivalent volume of stored fuel, which would substantially have the same energy content as the same volume of raw fuel. Such methods are intended to be within the scope of the instant invention. However, a better method of allocating the kinetic energy in real time as gallons of a stored fuel is more accurate and useful, and such methods will be discussed in more detail.

Another way to state the above is that the kinetic energy can be converted into the equivalent amount of related original heat (and the associated fuel volume) simply by dividing by, for example, the standard efficiency of the vehicle's powertrain. However, this simple procedure does not account for the fact that the powertrain efficiency is constantly changing and varies widely during the course of a trip. Measuring engine and powertrain efficiency dynamically provides a useful alternate approach to the embodiment described herein.

As discussed above, the motive power is delivered by the vehicle engine through the consumption of raw fuel at a rate of RAWgph (gallons of raw fuel consumed per hour). The portion of this power not used in overcoming road load is stored in the kinetic energy of said vehicle. Instead of keeping track of engine power directly, in this implementation the key parameters are the vehicle speed V and the rate R at which raw fuel is being consumed. The road load (power) RL(V) is known through previous experimentation or simulation as a function of vehicle speed V. The acceleration power AP going into vehicle acceleration is mVa, where the mass m of the vehicle is known, the vehicle speed V is measured, and the vehicle acceleration a is generated by differentiating the vehicle speed with respect to time.

Given the definitions of road load and acceleration power, it is clear that the total motive power TP=RL(V) +AP(m,V,a). Accordingly, the fraction of motive power being stored as kinetic energy of the vehicle is SPF=AP/TP. The rate at which stored fuel accumulates is then the rate of raw fuel consumption R times the stored power fraction SPF. As this is a contribution from positive acceleration, it is herein called SPF+.

The acceleration a of the vehicle is generated by element 103 as the time derivative of the output V of element 101, the vehicle speed.

Element 104 determines the acceleration power AP, which is the power which converted into kinetic energy as the vehicle accelerates. To do so, element 104 accepts as inputs the vehicle speed V from element 101 and the vehicle acceleration a from element 103, and multiplies them together with the vehicle weight m (typically stored as an approximate value in memory, but m may alternatively be measured in real-time, or corrected for the mass of the raw fuel consumed by the vehicle). AP=mVa. The output of element 104 equals AP if the vehicle acceleration is positive. Otherwise, the output of element 104 is set equal to zero.

Element 105 generates a value for the nominal road load of the vehicle based on the vehicle speed V, which it accepts as input from element 101. The road load RL(V) is the approximate power required to overcome the friction and drag associated with moving at a given velocity. For example, the road load at 50 mph is the power required to maintain 50 mph on a flat, smooth road.

As another example, the “road load” of a flying vehicle would depend at least on airspeed, altitude, and barometric pressure. Humidity might also have an influence.

While the road load can be determined in real-time given knowledge of the appropriate dynamic operating parameters of the vehicle, in practice Applicant has discovered that implementation of the instant invention based on a nominal road load approximation obtained from vehicle testing retains the general utility of the LIVEmpg value for many classes of applications. Revealing this discovery is not intended in any way to narrow the claimed invention.

For the purposes of this disclosure, accessory load power requirements are included into the road load of the vehicle for which LIVEmpg is being generated.

The total power TP being consumed by the vehicle is generated in element 106 by accepting as inputs the acceleration power AP from element 104 and the road load RL from element 105, and adding these together to generate the total power TP as the output of element 106.

To determine the fraction of the total power being stored in the vehicle's kinetic energy, element 107 first determines if the acceleration power is greater than zero. If AP is equal to or less than zero, element 107 produces an output of zero, indicating that none of the output of the vehicle engine is being stored during travel at constant speed or during deceleration.

When AP is greater than zero, element 107 divides the acceleration power AP by the total power TP, and outputs the stored power fraction. As this is the contribution to stored fuel during positive acceleration, this quantity is called SPF+. The stored power fraction is the fraction of the current fuel consumption that is being stored as kinetic energy of the vehicle.

Element 108 accepts as inputs the stored power fraction SPF+ from element 107 and the rate R of raw fuel consumption from element 102. Element 108 then multiplies the two inputs to obtain the rate of change of the stored fuel SRC+, and provides it as an output. SRC+ has units of volume per time, and can be converted for simplicity into gallons per hour. Note that this procedure automatically adjusts for the current efficiency of the vehicle in converting raw fuel into mechanical output.

In the implementation of the instant invention illustrated in FIG. 1, reduction of the stored fuel on deceleration is carried out by a feedback loop consisting of elements 109-112, which function together to calculate the reduction in the volume of stored fuel during periods of negative acceleration.

The differential rate of change of kinetic energy of the vehicle during deceleration is called CKV−, and is the rate of decrease of the vehicular kinetic energy divided by the vehicular kinetic energy. Thus

KE=½MV²

dKE/dt=MVa

CKV−=(dKE/dt)/KE=2a/V,

is computed by element 109 from the outputs of elements 101 and 103.

The rate at which stored fuel is being consumed is the current amount of stored fuel times CKV−, or

SRC−=stored fuel*(2a/V).

SRC− is the output of element 110. If the vehicle is decelerating, the amount of stored fuel is decreasing.

The output of element 111 is the total rate of change SRC in the amount of stored fuel. The inputs to element 111 are SRC+(the output of element 108),′ and SRC− (the output of element 110).

In element 112 the output SRC of element 111 is integrated over time to generate and provide as an output the total volume of stored fuel SF stored at any moment during the motion of the vehicle.

Element 110 accepts SF and the correction factor CKV− from 109 as inputs, and multiplies them together to generate SRC− as an output then provided to element 111 to close the feedback loop.

Element 109 accepts as input the vehicle acceleration a, and the vehicle speed V. If a is less than zero, the output of element 109 is set to 2a/V (the fractional rate of reduction of the amount of stored fuel due to deceleration). Otherwise, the output of element 109 is set to zero. This output is a pure rate, having units of inverse time.

Note that the change of the volume of stored fuel both for acceleration and deceleration is automatically adjusted to reflect the current raw fuel efficiency of the vehicle engine and drivetrain. While this is not necessary to produce a LIVEmpg value, it often increases the utility of the LIVEmpg value.

Element 113 accepts as inputs the rate of raw fuel consumption RAWgph from element 102 and the total rate of change of the volume of stored fuel SRC from element 111. The output of element 113 is called the Live gallons per hour, or LIVEgph. In this implementation, LIVEgph=RAWgph−SRC.

Finally, element 114 accepts as inputs the vehicle speed V from element 101 and the LIVEgph from element 113. Element 114 then provides as an output the LIVEmpg value, which is equal to vehicle speed divided by LIVEgph.

In the implementation of FIG. 1, the LIVEmpg parameter is provided to display 115 to guide the vehicle operator in how to minimize the amount of fuel used during operation. Note that the LIVEmpg parameter may be used in other ways, including providing feedback to cruise control, braking systems, and semi-autonomous and autonomous driving controllers.

While the above implementation generates a useful value for LIVEmpg, it is possible for errors to accumulate in the total amount of stored fuel calculated by element 112. (The derivatives required by the implementation of FIG. 1 are notorious as sources for numerical error and instability.)

Such accumulated error would cause the total amount of raw fuel consumed during a trip and the total amount of fuel consumed as calculated by dividing the trip distance by the average LIVEmpg to have different values. A noticeable difference in the average raw mpg and the average LIVEmpg during or at the end of a trip might well confuse a vehicle operator. While these errors can be reduced by careful design techniques known in the art, it is useful as well to consider an implementation in which the average LIVEmpg is corrected to substantially equal the average raw mpg.

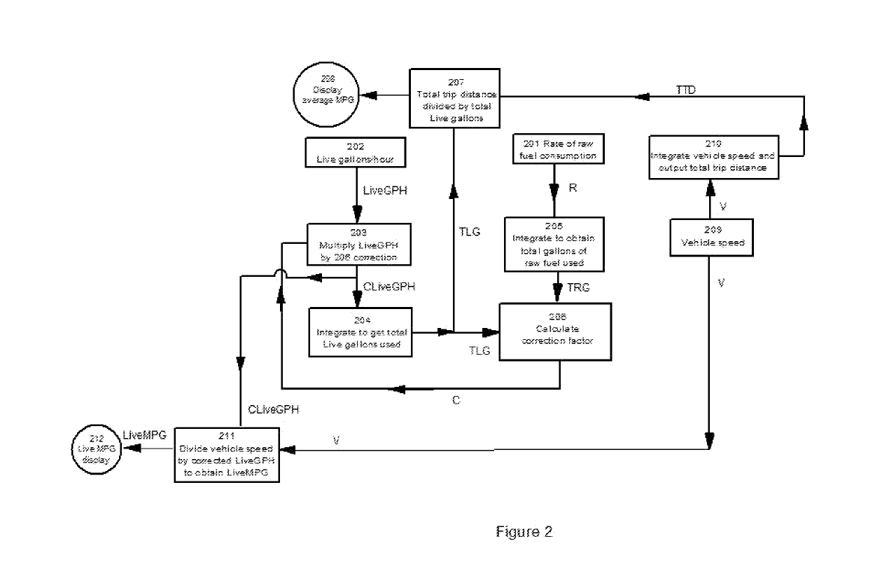

In FIG. 2 appears an implementation of the instant invention that continually corrects the LIVEmpg value so that the average LIVEmpg remains substantially equal to the average raw mpg, but the benefits of knowing the instantaneous LIVEmpg value are preserved.

In FIG. 2, the vehicle's dynamic operating parameters of rate of raw fuel consumption RAWgph and vehicle speed V are entered through elements 201 and 209, respectively. The LIVEgph is determined by a method and system, one implementation of which appears in FIG. 1, and is entered through element 202.

A time-varying correction factor between the LIVEgph value and the Corrected LIVEgph (CLIVEgph) value is to be generated that forces the total gallons of Live fuel used at any point in a trip to be substantially equal to the total gallons of raw fuel used at that same point in the trip. The correction factor is set through the action of the proportional integral control loop element 206. TRG, the total gallons of raw fuel consumed during a given trip, is generated in element 205, which integrates the rate RAWgph of raw fuel consumption input from element 201. LIVEgph is multiplied by a correction factor C from element 206 in element 203, whose output is then integrated in element 204 to output the total gallons of Live fuel TLG.

Element 206 accepts as inputs TLG and TRG, and generates therefrom a correction factor C, which is provided as an input to element 203. The correction factor C is a predetermined function of TLG and TRC. A simple function for C is simply C=2−TLG/TRG. If TLG is larger than TRG, the correction factor slightly reduces the value of LIVEgph, while if TRG is larger than TLG, the correction factor slightly increases the value of LIVEgph. The actual function is chosen so that the PI control loop produces the desired result (that TLG is substantially equal to TRG) without introducing error and/or oscillation that is excessive for a given application.

Element 207 accepts as input the current value for total Live gallons TLG from element 204, and the total trip distance TTD from element 210, which represents the integral of the vehicle speed from element 209. The output of element 207 is the average MPG, which is simply TTD/TLG. This output is then displayed in display 208.

The corrected LIVEmpg (CLMPG) value is generated as the output of element 211, which accepts as input CLIVEgph from element 203 and the vehicle speed from element 209. The corrected rate of live fuel consumption CLIVEMPG is generated by dividing the vehicle speed by the CLIVEgph value. The output of element 211 is then displayed to the operator via display 212.

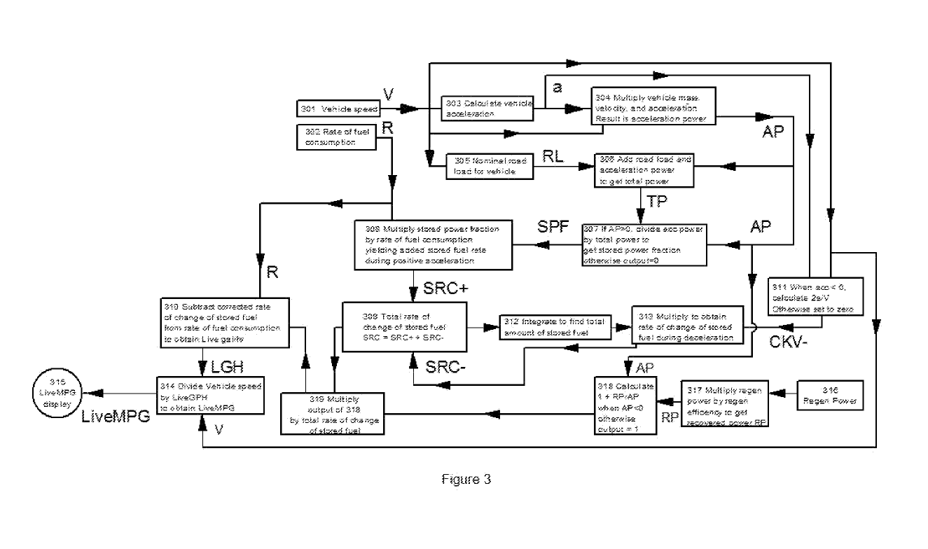

FIG. 3 shows an implementation of the instant invention that corrects LIVEmpg for the effects of regenerative braking. A regenerative brake is an energy recovery mechanism which slows a vehicle by converting its kinetic energy into another form, which can be either used immediately or stored until needed. Said other form is most commonly electricity stored temporarily in a battery, but any form of energy storage (e.g., a flywheel) that can be coupled to the kinetic energy of a vehicle can be used for this purpose. This contrasts with conventional braking systems, where the excess kinetic energy is converted to heat by friction in the brake linings and therefore wasted. The use of a regenerative brake is called regenerative braking.

A typical regenerative brake for land vehicles comprises an electric generator and a storage battery. When an operator wants to slow or stop a vehicle equipped with regenerative braking, an electric generator is connected to the wheels and a storage battery. As the electric generator is driven by the wheels, it generates electricity, and in the process induces a drag on the wheels which acts as a braking mechanism. The output of the electric generator is substantially stored in the storage battery.

Note that in electric and hybrid vehicles, the electric generator is usually the electric motor of the vehicle configured so as to act as a generator.

The energy stored during regenerative braking can later be directed through an electric motor to accelerate the vehicle; to maintain the speed of the vehicle; to make the vehicle decelerate more slowly than would result from road load; or to power other functions of the vehicle (e.g., air conditioning or auxiliary tools.)

Such regenerative braking systems are quite efficient, being able to return as much as 85% of the electric energy generated during braking back into kinetic energy of a vehicle. There are, however, limitations of regenerative braking that usually require conventional friction brakes to be used in conjunction with regenerative braking.

For example, the deceleration rate that can be provided by regenerative braking cannot be larger than that corresponding to the drag induced by the electric generator, a value that depends significantly on the vehicle speed. Deceleration is also limited by the ability of the storage battery to accept and store electric power, unless at high deceleration rates the output of the electric generator is diverted to a resistive load.

Because of these factors, a regenerative braking system often cannot bring a vehicle to a complete stop within a reasonable distance or a safe distance. In addition, more braking capacity may be needed at times for emergency maneuvers.

As a result, most electric land vehicles incorporate a cooperative braking system that comprises both friction brakes and regenerative brakes, together with a control system that balances the drag of the two types of brakes to maximize overall energy efficiency of the cooperative braking system.

Much of the description of the regenerative braking implementation in FIG. 3 follows that following FIG. 1. First we examine the calculation of the storage of kinetic energy as stored fuel during positive vehicle acceleration a. This is carried out by elements 301-308. The rate at which stored energy fuel accumulates during positive acceleration is the variable SPF+. Each element accomplishes the same task as the equivalent element in FIG. 1, a fact emphasized by using the same trailing digits to identify the elements.

Similarly, elements 301, 303, 309, and 311-313 account for the change in the amount of stored fuel during periods of negative acceleration. The rate of consumption of stored energy fuel during periods of negative acceleration is the variable SRC−.

Elements 302, 310, and 316-319 generate a LIVEgph rate adjusted for the effects of regenerative braking. The magnitude of the power being generated and stored by the regenerative braking system is made available as the output of element 316. Element 317 then multiplies this power by the nominal electric propulsion path efficiency EPE to generate the recovered power RP as output. As usual, this efficiency can be measured in real-time, but the instant invention often functions well with a simple (possibly constant) conversion factor.

In element 318 a regenerative braking correction factor is generated as the equation 1+RP/AP. Note that when the vehicle acceleration a is negative, RP is positive while AP is negative, so that this correction factor is smaller than one. When AP is positive or zero, the output of element 318 is 1.

Element 319 multiplies the output of element 318 by the total rate of change of stored fuel SRC, which is the output of 309. This produces the output of element 319, the total rate of change of the stored fuel volume adjusted for the effects of regenerative braking, or CSRC.

In generating the regenerative braking correction, the system offsets a portion of the stored fuel consumption from deceleration by the amount of fuel equivalent to the energy recovered by the regenerative braking system.

By definition, the offsetting of fuel consumption creates a variance with raw fuel consumption measurements. This variance can be corrected by the control loop discussed in FIG. 2 when such correction is desirable.

Element 310 accepts as inputs the rate of raw fuel consumption R from element 302 and the adjusted rate of change of stored fuel CSRC from element 319. It generates the adjusted LIVEgph value by subtracting CSRC from R, and then makes it available as an output called CLIVEgph.

Element 314 divides the vehicle speed V from element 301 by the adjusted CLIVEgph, and provides as output the adjusted LIVEmpg value, which is then displayed by element 315.

The LIVEmpg generated by this implementation of the instant invention is generally larger than that generated by the implementation of FIG. 1. This follows because regenerative braking increases the overall efficiency of the vehicle by recapturing the kinetic energy on braking, rather than losing that energy to generation of heat.

Note that the same basic approach to generating LIVEmpg values can be applied to a hybrid vehicle, when a portion of the power generated by a chemical engine is split off and used to charge batteries which can power an electric engine at a later time.

It is also possible to include the effect of changes in potential energy in a LIVEmpg value. If a land vehicle has driven to the top of a hill, it has stored energy that will be released when the vehicle drives down the hill. Including such changes in elevation is unimportant in flat terrain, but they can be significant in hilly terrain, or when an area is laid out on a significantly sloping site.

For example, the elevation of Albuquerque, N. Mex. ranges from 1,490 meters above sea level near the Rio Grande to nearly 2,000 meters in the eastern foothills. These two extremes are separated by roughly a distance of about 16 kilometers—an average slope of about 3%. If a land vehicle weighing 3500 kg made that trip, the change in potential energy would be 17.5 megajoules, or the energy equivalent of 0.13 gallons. To acquire an equivalent amount of kinetic energy, the same vehicle would have to travel at over 200 mph. Potential energy can be a useful and significant input for increasing the utility of an EDFED value.

Consider the energetics of a vehicle going up or down a hill at a constant speed. The potential energy of the vehicle is

PE=mgh,

where m is the mass of the vehicle, g is the Earth's gravitational acceleration, and h is the elevation of the vehicle. As the elevation of the vehicle changes, the power stored in the potential energy of the vehicle is proportional to the rate of change of the elevation:

PP=mg(dh/dt)=mgVₕ,

where Vₕ is the vertical speed of the vehicle.

Similar to the case of the implementation for kinetic energy in FIG. 1, the total power generated by the engine to climb this slope at constant velocity is

TP=PP+RL,

where RL is the energy cost of traveling on a flat surface at a constant velocity. And as before, the fraction of the current energy output of the engine that is being stored in the potential energy of the vehicle is the stored potential power fraction SPPF=PP/TP. The main difference here is that it makes sense to have a negative amount of stored fuel when including potential energy—it simply corresponds to a situation where the vehicle has gone to a lower altitude during driving. Correcting for stored potential energy is then accomplished in analogy to correction for stored kinetic energy, as will be clear to one skilled in the art.

When the foregoing description of the instant invention called out a particular vehicle, a wheeled land vehicle such as a car, truck, or motorcycle was specifically mentioned. However, the scope of the instant invention is not limited to such vehicles. Similar analyses carried out by the present method and system can provide LIVEmpg values for airborne vehicles, waterborne vehicles, hovercraft, and even rocket vehicles and spacecraft can profit by access to the vehicle operational data compressed into a LIVEmpg value. Applicants intend that all such modes of vehicular activity in which utility is found in an analogy of the LIVEmpg value clear to one skilled in the art are within the scope of the instant invention.

While the foregoing written description of the invention enables one of ordinary skill to make and use what is considered to be the best mode thereof, those of ordinary skill will also understand and appreciate the existence of variations, combinations, and equivalents of the specific embodiment, method, and examples herein. The invention is therefore not intended to be limited by the above described embodiments, methods, and examples, but by all embodiments and methods within the scope and spirit of the invention as claimed below.

1. A method and system for generating a LIVEmpg value for a vehicle powered by at least one engine consuming a raw fuel, comprising the steps of:
i. measuring the rate of raw fuel consumption (RAWgph);
ii. measuring the vehicle speed V of said vehicle;
iii. correcting the rate of raw fuel consumption to reflect changes in stored kinetic energy of said vehicle; and
iv. dividing the vehicle speed V by the corrected rate of raw fuel consumption to obtain said LIVEmpg value.

2. The method and system of claim 1, wherein the step of adjusting the rate of raw fuel consumption to reflect changes in stored kinetic energy of said vehicle comprises:
i. generating a value for vehicle acceleration a;
ii. generating a value for acceleration power AP;
iii. generating a value for road load RL;
iv. determining a value for the fraction SPF+ of total mechanical power being converted into stored fuel during positive acceleration; and
v. multiplying SPF+ by RAWgpm to obtain the rate STOREDgph at which stored fuel is being accumulated.

3. The method and system of claim 1, wherein the step of adjusting the rate of raw fuel consumption to reflect changes in stored kinetic energy of said vehicle comprises:
i. generating a value for vehicle acceleration a;
ii. generating a value for CKV− during negative acceleration;
iii. multiply volume of stored fuel by CKV− to find the rate of change of stored fuel SRC−;
iv. generate a total rate of change SRC of the volume of stored fuel by adding together all sources of stored fuel rate of change;
v. generate a LIVEgph value by subtracting SRC from RAWgph, and,
vi. divide the vehicle speed by LIVEgph to obtain LIVEmpg.

4. The method and system of claim 1, wherein said raw fuel comprises a chemical fuel.

5. The method and system of claim 1, wherein said raw fuel comprises petroleum products.

6. The method and system of claim 1, wherein said raw fuel comprises an alcohol.

7. The method and system of claim 1, wherein said raw fuel comprises electrical energy.

8. The method and system of claim 1, further comprising means to adjust LIVEgph values so that the total amount of live fuel used in a trip is substantially equal to the total amount of raw fuel used on that same trip.

9. The method and system of claim 7, wherein said means to adjust comprise:
i. determining the amount of raw fuel used during a trip;
ii. generating an uncorrected LIVEgph value;
iii. correcting said LIVEgph value to obtain substantial consistency between the amount of live fuel used during a trip and the total amount of raw fuel used during the same trip; and,
iv. integrating the corrected LIVEgph value to obtain the amount of live fuel used during a trip.

10. A method and system for generating a LIVEmpg value for a vehicle powered by an engine consuming a raw fuel and further comprising a regenerative braking system, said regenerative braking system comprising:
i. an electric generator to convert the kinetic energy of said vehicle into electric energy during regenerative braking;
ii. means to monitor and store the electric energy generated during regenerative braking;
iii. an electric motor to convert the stored electric energy into motive power when desired; and,
iv. means to deliver the stored electric energy to said electric motor.

11. The method and system of claim 9, wherein said electric generator and said electric motor are embodied in a single electrical machine.

12. The method and system of claim 9, wherein generating a LIVEmpg value comprises:
i. measuring the quantity of electric energy generated and stored in said means to monitor and store during regenerative braking; and,
ii. offsetting the reduction of stored fuel which occurs during regenerative braking by said quantity of electrical energy for the purpose of calculating said LIVEmpg value.

13. The method and system of claim 11, further comprising means to adjust the quantity of electrical energy by the efficiency of the electric motor and drivetrain.
